(19) United States
(12) Patent Application Publication
(10) Pub. No.: US 2007/0188606 A1
(43) Pub. Date: Aug. 16, 2007

(54) Vision-based position tracking system

(76) Inventors: Kevin Atkinson, Windsor (CA); Nikola Dimitrov, Tecumseh (CA); Ross Rawlings, Belle River (CA)

Correspondence Address: Ralph A. Dowell of DOWELL & DOWELL P.C., 2111 Eisenhower Ave, Suite 406, Alexandria, VA, 22314, US

(21) Appl. No.: 11/520,782

(22) Filed: Sep. 14, 2006

Related U.S. Application Data
(60) Provisional application No. 60/773,686, filed on Feb. 16, 2006.

(51) Int. Cl. H04N 7/18

(52) U.S. Cl. 348/95; 348/130

(57) ABSTRACT

The invention is directed to a tracking system for tracking the use of an object on a work piece within a predetermined work space comprising a target, at least one video imaging source and a computer. The target is attached to the object and calibrated to derive an “Object Tracking Point”. Each target has a predetermined address space and a predetermined anchor. At least one video imaging source is arranged such that the work piece is within the field of view. Each video imaging source is adapted to record images within its field of view. The computer is for receiving the images from each video imaging source and comparing the images with the predetermined anchor and the predetermined address, calculating the location of the target and the tool attached thereto in the work space relative to the work piece.

### CROSS REFERENCE TO RELATED PATENT APPLICATION

This patent application relates to U.S. Provisional Patent Application Ser. No. 60/773,686 filed on Feb. 16, 2006 entitled A VISION-BASED POSITION TRACKING SYSTEM which is incorporated herein by reference in its entirety.

### FIELD OF THE INVENTION

The present invention is related generally to a method for visually tracking an object in three dimensions with six degrees of freedom and in particular to a method of calculating the position and orientation of a target attached to an object and further calculating the position and orientation of the object's tracking point.

### BACKGROUND OF INVENTION

There is a need in manufacturing to be able to record specific predetermined events relating to sequence and location of operations in a work cell. For example the recording of the precise location and occurrence of a series of nutrunner tightening events during a fastening procedure would contribute to the overall quality control of the manufacturing facility.

A number of systems have been proposed which attempt to track such events but each system has some specific limitations which make if difficult to use in many manufacturing facilities. Some of the system proposed include ultrasound based positioning systems and linear transducers.

Specifically U.S. Pat. No. 5,229,931 discloses a system relating to a nutrunner control system and a method of monitoring nutrunner control system such as drive conditions for the nutrunners are set up and modified by a master controller, the nutrunners are controlled through subcontrollers and operating conditions of the nutrunners are monitored by the master controller through the subcontrollers. The primary object is to provide a nutrunner control system and a method of monitoring nutrunners, which allow drive conditions to be preset and modified. However, the system does not monitor which particular nut is being acted upon.

Ultrasound tracking is a six Degrees of Freedom (DOF) tracking technology, featuring relatively high accuracies (in the order of 10 millimeters), and a high update rate (in the tens of hertz range). A typical system consists of a receiver and one or more emitters. The emitter emits an ultrasound signal from which the receiver can compute the position and orientation of the emitter. However, ultrasound tracking does not work in the presence of loud ambient noise. In particular, the high frequency metal-on-metal noise that is abundant in a heavy manufacturing environment would be problematic for such a system. In such an environment accuracy degrades to the point of uselessness. As well, these systems are relatively expensive.

A three degrees of freedom (3 DOF) tracking technique that is used frequently in robot calibration involves connecting wires to three linear transducers. The transducers measure the length of each wire, from which it is possible accurately to calculate the position of an object to which the wires are attached. It's a simple, accurate technique for measuring position, but it is ergonomically untenable for most workspace situations. Quite simply, the wires get in the way. Another shortcoming of this approach is that it only tracks position, rather than position and orientation. Theoretically, one could create a 6 DOF linear transducer-based system, but it would require 6 wires, one for each degree of freedom. From an ergonomic and safety perspective, such a system would not be feasible.

A review of products available on the market showed that no system existed to perform this operation. Solutions with either the acoustical tracking system or linear transducer system were explored by the inventors but rejected in favor of the vision based solution described herein. Further, a vision based solution provided the ergonomic, easily retrofitted, reliable, maintainable, low cost system that the customer required. A proof of concept was obtained with a single camera, single nutrunner tool station. The original proof of concept system was refined and extended to the invention described herein.

A vision based system was developed by the inventors in order to track an object's position in three dimensional space, with x,y,z, yaw, pitch, roll (ie. 6 DOF) as it is operated in a cell or station. By taking the vision-based position tracking communication software and combining it with a customized HMI application, the invention described herein enables precision assembly work and accountability of that work. The impact of this capacity is the ability to identify where in the assembly operation there has been a mis-step. As a result assembly operations can be significantly improved through this monitoring.

### SUMMARY OF THE INVENTION

The object of the present invention is to track an object's position in three dimensional space, with x,y,z and yaw, pitch, roll coordinates (ie. 6 DOF), as it is operated in a cell or station. Further, the information regarding the position of the object is communicated to computing devices along a wired or wireless network for subsequent processing (subsequent processing is not the subject of this invention; simply the provision of pose information is intended).

The invention is an integrated system for tracking and identifying the position and orientation of an object using a target that may be uniquely identifiable based upon an image obtained by a video imaging source and subsequent analysis within the mathematical model in the system software. It scales from a single video imaging source to any number of video imaging sources, and supports tracking any number of targets simultaneously. It uses off-the-shelf hardware and standard protocols (wire or wireless). It supports sub-millimeter-range accuracies and a lightweight target, making it appropriate for a wide variety of tracking solutions.

The invention relies upon the fixed and known position(s) of the video imaging source(s) and the computed relationship between the target and the tool head or identified area of interest on the object to be tracked, also referred to as the object tracking point. The target, and thus the tracking function of the invention, could be applied equally to nutrunner guns, robot end of arm tooling, human hands, and weld guns to name a few objects.

The invention is directed to a tracking system for tracking one or multiple objects within a predetermined work space comprising a target mounted on each object to be tracked, at least one video imaging source and a computer. The target is attached to the object at a fixed location, then calibrated to the object tracking point. Each target has a predetermined address space and a predetermined anchor. Then at least one video imaging source is arranged such that the area of interest is within the field of view. Each video imaging source is adapted to record images within its field of view. The computer is for receiving the images from each video imaging source and comparing the images with the predetermined anchor and the predetermined address, calculating the location of the target and the tool attached thereto in the work space.

In another aspect the invention is directed to a tracking system for tracking a moveable object for use on a work piece within a predetermined workspace comprising: a target adapted to be attached to an object; a video imaging source for recording the location of the object within the workspace; and a means for calculating the position of the object relative to the work piece from the recorded location.

### BRIEF DESCRIPTION OF THE DRAWINGS

The invention will now be described by way of example only, with reference to the accompanying drawings, in which:

FIG. 1 is a diagram of a typical configuration of the vision based position tracking system according to the present invention;

FIG. 2 is a perspective view of a nutrunner with the uniquely identified target of the present invention attached thereto;

FIG. 3 is a view similar to that shown in FIG. 1 but showing three video sources;

FIG. 4 is an illustration of a portion of the nutrunner with a target attached thereto as used in an engine block;

FIG. 5 is a view of the target mounted on an alternate moveable object; and

FIG. 6 is view similar to that shown in FIG. 5 but showing a multi-faced target attached to a moveable object.

### DETAILED DESCRIPTION OF PREFERRED EMBODIMENTS

The present invention will now be described more fully hereinafter with reference to the accompanying drawings, in which preferred embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art. Like numbers refer to like elements throughout.

As will be appreciated by one of skill in the art, the present invention may be embodied as a method, data processing system or program product. Furthermore, the present invention may include a computer program product on a computer-readable storage medium having computer-readable program code means embodied in the medium. Any suitable computer readable medium may be utilized including hard disks, CD-ROMs, optical storage devices, or magnetic storage devices.

The tracking system of the present invention is a technology for visually tracking the position and orientation of an object in a work cell. The following four scenarios are some of examples of the use for the tracking system of the present invention.
Scenario 1: the automatic nutrunner fails on one or more nuts. The engine stops at the subsequent manual backup station. The operator gets notified and locates the failed nut(s). The failed nut(s) are loosened and then the programmed torque is applied with a manual torque tool to only the failed nut(s).
Scenario 2: the automatic nutrunner fails on one or more nuts. The engine enters a repair bay requiring that certain nuts be torqued. The operator uses a manual torque tool to torque each of the failed nuts.
Scenario 3: during a manual assembly the operator is required to fasten more than a single critical torque with verification that each of the critical torques have been completed
Scenario 4: during a manual assembly operation the operator is required to fasten the nuts/bolts in a specific sequence. In any of the above cases if the operator errs and misses a bolt, or torques the wrong bolt, there is currently no reliable way to catch the error.

There are many production situations where knowing the position and orientation of an item may be valuable for quality assurance or other purposes. The following is a variety of scenarios where this technology can be applied. In an industrial/manufacturing environment this technology can be used to track an operator fastening a set of “critical-torque” bolts or nuts to ensure that all of them have in fact been tightened (the vision feedback is correlated with the torque gun feedback to confirm both tightening and location of tightening). In another industrial/manufacturing scenario a worker performing spot welding can be tracked to ensure that all of the critical junction points have been spot welded (again, correlating the vision information with the welding unit's operating data to confirm both welding and location of welding). In a mining or foundry environment this technology can be used to track large objects (like crucibles containing molten metal) by applying the target to the container instead of on a machine tool in order to calculate precise placement in a specific location required by the process. Prior technology for tracking large objects with only cameras may not deliver the required accuracy. In a packaging industry this technology can be used to pick up/drop off, orient and insert packages via automation. Each package can have a printed target in a specific location that can be used by the vision system to determine the package orientation in 3D space. Another use of this technology is docking applications. An example of this is guiding an aircraft access gate to the aircraft door autonomously. This can be accomplished by printing/placing a target at a known location on the aircraft door and the vision system mounted on the aircraft access gate with capability to control the access gate motors.

Other possible applications for this technology beyond the automotive and aviation sectors to consider are marine, military, rail, recreation vehicles such as ATV's, skidoos, sea-doos and jet skis, heavy duty truck and trailer productions.

The tracking system of the present invention uses a state of the art visual tracking technology to track a target permanently mounted on the object. The tracking system can track the target and can report the object's tracking point in space upon a request. That information can be used to determine if the correct nut/bolt has been fastened, to use the example of a nutrunner system whereby the object's tracking point is the socket position.

The tracking system herein tracks the position and orientation of a handheld object in a given work space in three dimensions and with six degrees of freedom. It can confirm a work order had been completed. It can communicate results. It can achieve high levels of consistency and accuracy.

The tracking system has real time tracking capabilities with 5-30 frames per second. It supports one or multiple video imaging sources. It provides repeatable tracking of 1 mm with a standard system configuration (ie. 1 square meter field of view with a 3 cm target). It supports generic camera hardware. It can show images for all the video images sources attached to the system. It can show 3D virtual reconstruction of targets and video imaging source.

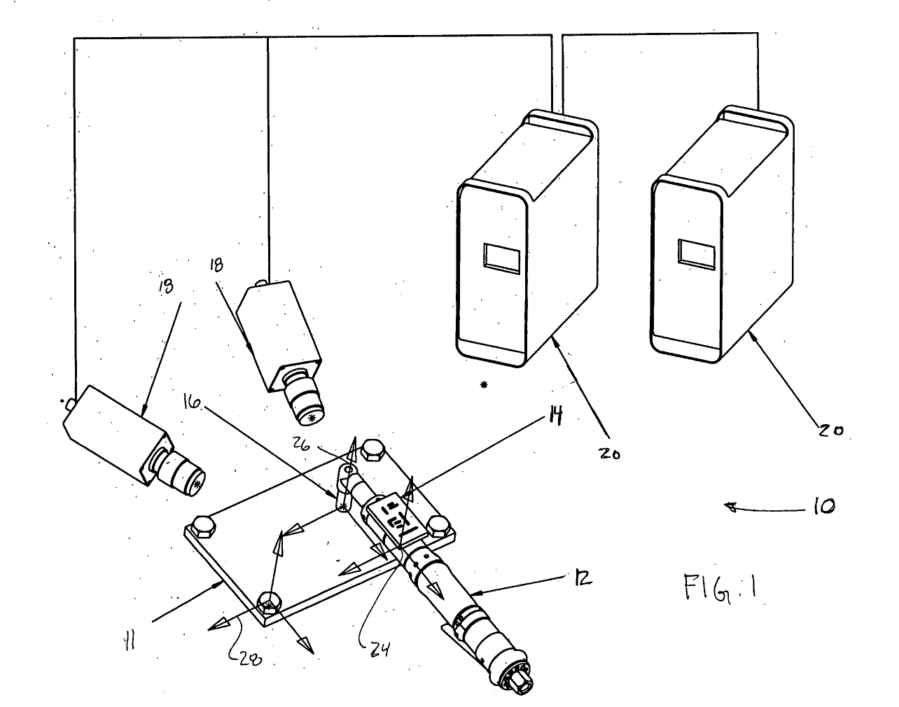

Referring to FIG. 1 the main components of the tracking system of the present invention 10 are shown. There is a work piece 11, such as an engine assembly (the work piece itself is incidental to the present invention), being worked on with an object 12 such as a nutrunner, which has a target 14 attached thereto. The object tracking point offset 16, such as the fastening socket of the nutrunner, is calculated for the object.

The system method is such that images of the target 14 are acquired by one or more fixed video imaging sources 18 mounted on a framework (not shown). The framework can be customized to the requirements of the manufacturing cell. Those images are analyzed by a computer which can be an embedded system or a standard computer 20 running the software, and the results are sent over a wireless or wired network to networked computers 22. The axes on the target, end-of-device and the work piece 24, 26, and 28 respectively represent the results, which are the respective x, y, z and yaw, pitch, roll coordinate systems which are calculated by the software.

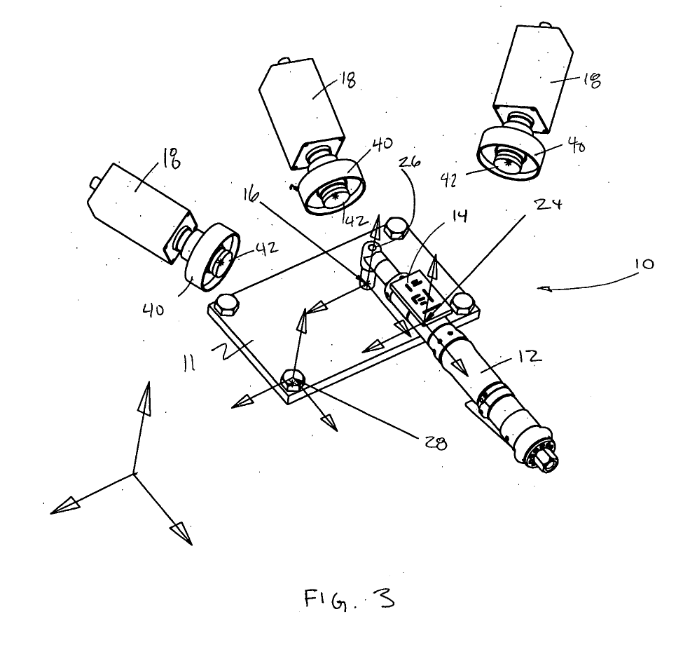

FIG. 3 illustrates the objective of the tracking system of the present invention which is to monitor the position (x, y, z, yaw, pitch, roll) of a user predefined point on an object 12. The predefined point is identified with a target 14. When this target 14 is within a user defined volume around the point of interest or work piece 11, the tracking system of the present invention can either set outputs and/or send TCP/IP data to connected devices (not shown). The tracking system does this by actively monitoring the position of the target 14 relative to a known point 16 of one or more uniquely coded targets 14 and by using a calibration function determines the position of the object 12. One or more video imaging sources 18 can be used to create a larger coverage area with greater positional accuracy. Millimeter-range accuracies are practicably achievable over tracking volumes approaching a cubic meter.

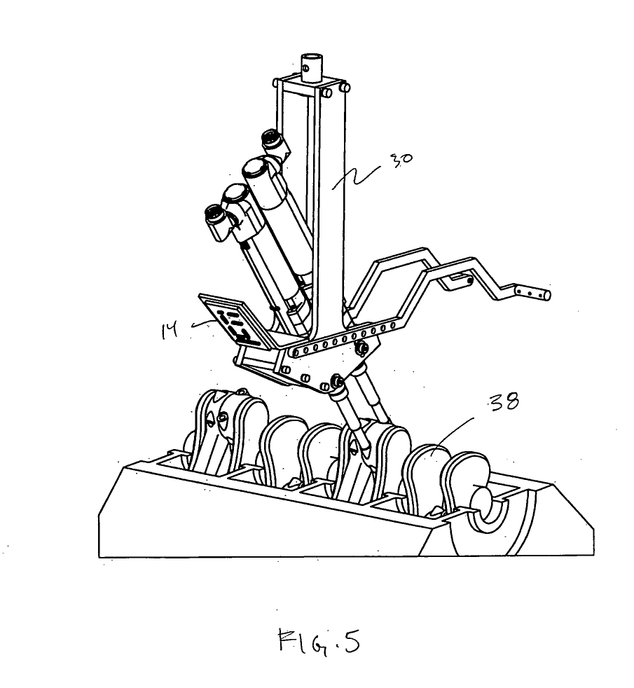

The video imaging sources(s) 18 are mounted in such a way as to ensure that the target on the section of interest of the work piece 11 is within the field of view of the video imaging source, thus providing an image of the target 14 to the analyzing computer. While the present system is described with respect to a manufacturing cell or station where lighting conditions are stable thus enabling that no specialized lighting is shown in the illustration in FIGS. 1 and 5, as will be appreciated by those of skill in the art, the teachings of the present invention may also be utilized in conjunction with additional lighting.

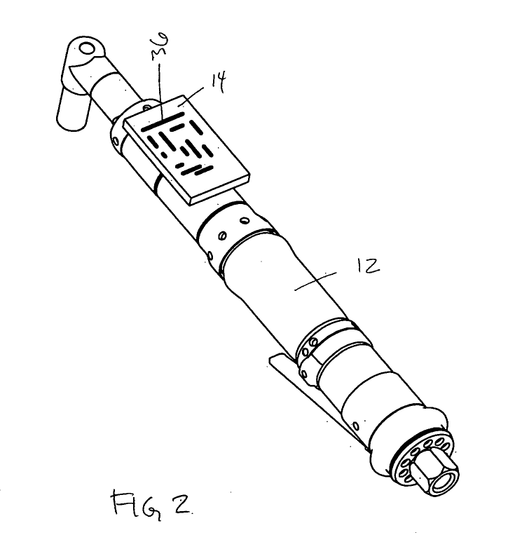

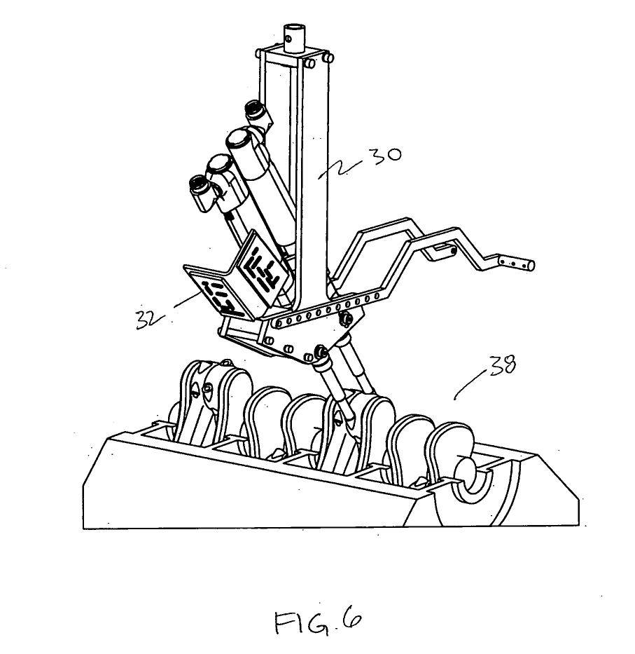

One face of a target 14 is shown in FIG. 2. The target 14 can be sized to any scale which is practical for the given application and may have multiple faces. For instance, on a small hand-held device, it might be 2 cm high; for a large device, it might be two or three times that. Accuracy will degenerate as the target gets smaller (the size of the target in pixels in the image is actually the limiting factor), so the general rule is to make it as large as is ergonomically feasible. A single face target 14 mounted to a hand-held nutrunner gun 12 is shown in FIG. 1. FIG. 5 shows a single face target 14 attached to an alternate tool 30 and FIG. 6 shows a multi-faced target 32 attached to a similar tool 30.

The pattern on the target 14 face can encode a number which uniquely identifies the target; it can also be an arrangement of patterns that may not uniquely identify the target but still provide the information to calculate the pose estimation. Currently targets can support a 23-bit address space, supporting 8,388,608 distinct IDs, or 65,536 or 256 or separate IDs with varying degrees of Reed-Solomon error correction. Alternatively the pattern on the target can be a DataMatrix Symbol.

While the present system is described with respect to a target with the pattern arrangement that can be read as a unique identification number, as will be appreciated by those of skill in the art, the teachings of the present invention may also be utilized in conjunction with a target that simply has a pattern arrangement that provides the minimum number of edges for pose estimation. Further, multiple faces on the target may be required for tracking during actions which rotate the single faced target out of the field of view of the camera(s).

The target 14 defines its own coordinate system, and it is the origin of the target coordinate system that is tracked by the system. The software automatically computes the object tracking point offset for an object i.e. the point on the object at which the “work” is done, the point at which a nutrunner fastens a bolt, for example (item 17 in FIG. 1). As an alternative, the option for entering the object tracking point offset manually is available.

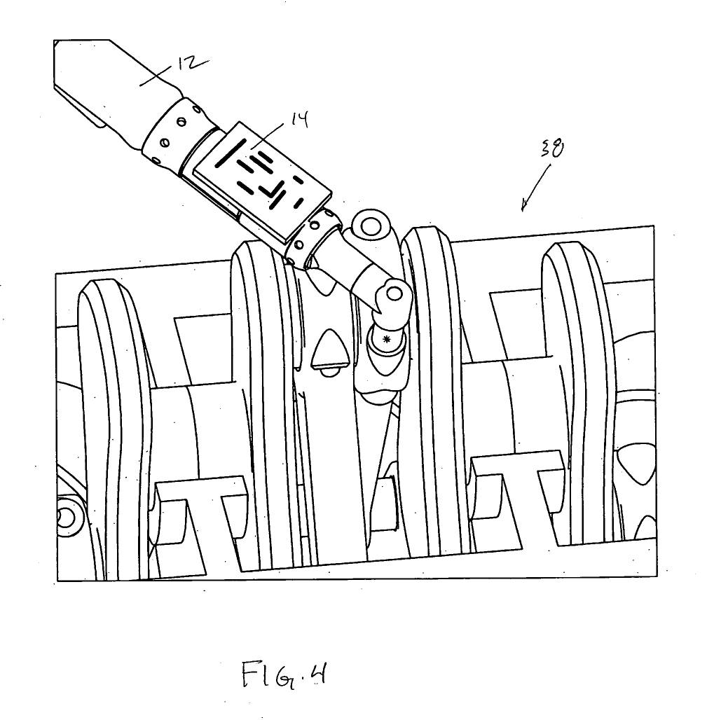

The end result is that the system will report the position of the object tracking point in addition to the position of the target. FIGS. 4, 5 and 6 show the tracking system of the present invention as it can be used in an assembly plant in relation to an engine block 38. It will be appreciated by those skilled in the art that the tracking system of the present invention could also be use in a wide variety of other applications.

The automatic object tracking point computation procedure works as follows:
1) The object is pivoted around the object tracking point. A simple fixture can be constructed to allow this pivoting.
2) While the object is pivoting around its object tracking point, the pose of the object-mounted target is tracked by the system.

To compute the object tracking point offset, the following relationship is used:

p=P_{CD}v

Where p is the position of the pivot point in the video imaging source coordinate system, P_{CD} is the pose of the target with respect to the video imaging source, and v is the end-of-tool offset in the target coordinate system. Alternatively, if R and t are the rotation and translation of the target with respect to the video imaging source, then

p=Rv+t

or

p−Rv=t

which yields the following linear system:

$$[ \begin{matrix}100 - {r}_{11}^{1} - {r}_{12}^{1} - {r}_{13}^{1} \\ 010 - {r}_{21}^{1} - {r}_{22}^{1} - {r}_{23}^{1} \\ 001 - {r}_{31}^{1} - {r}_{32}^{1} - {r}_{33}^{1} \\ ⋮ \\ 100 - {r}_{11}^{n} - {r}_{12}^{n} - {r}_{13}^{n} \\ 010 - {r}_{21}^{n} - {r}_{22}^{n} - {r}_{23}^{n} \\ 001 - {r}_{31}^{n} - {r}_{32}^{n} - {r}_{33}^{n}\end{matrix} ] [ \begin{matrix}{p}_{x} \\ {p}_{y} \\ {p}_{z} \\ {v}_{x} \\ {v}_{y} \\ {v}_{z}\end{matrix} ] = [ \begin{matrix}{t}_{x}^{1} \\ {t}_{y}^{1} \\ {t}_{z}^{1} \\ ⋮ \\ {t}_{x}^{n} \\ {t}_{x}^{n} \\ {t}_{x}^{n}\end{matrix} ]$$

Where the rⁱⱼₖ are the jk-th elements of the i-th rotation matrix, and the tⁱⱼ are the j-th elements of the i-th translation vector. The system is solved using standard linear algebraic techniques and take v as the object tracking point offset.

The application acquires streaming gray-scale images from the video imaging source(s), which it must analyze for the presence of targets. A range of machine vision techniques are used to detect and measure the targets in the image and mathematical transformations are applied to the analysis.

The sequence of operations is such that first the image is thresholded. Generally a single, tunable threshold is applied to the image, but the software also supports an adaptive threshold, which can substantially increase robustness under inconsistent or otherwise poor lighting conditions. Chain-code contours are extracted and then approximated with a polygon.

Identifying the identification number of the target is not necessary to track the target in space. It will be of use if multiple objects are tracked in the same envelope.

Each contour in the image is examined, looking for quadrilaterals that 1) have sub contours; 2) are larger than some threshold; 3) are plausible projections of rectangles. If it passes these tests, the subcontours are examined for the “anchor” 36—the black rectangle at the bottom of the target depicted in FIG. 2.

If the anchor is detected, the corners of the target and the anchor are extracted, and used to compute the 2D homography between the image and the target's ideal coordinates. This homography is used to estimate the positions of the pattern bits in the image. The nomography allows the software to step through the estimated positions of the pattern bits, sampling the image intensity in a small region, and taking the corresponding bit as a one or zero based on its intensity relative to the threshold.

When sampling the target there should be good contrast of black and white. This is actually the final test to verify that a target has been identified. K-means clustering is used to divide all pixel measurements into two clusters, and then verify that the clusters have small variances and are nicely separated.

An essential and tricky step is refining the estimated corner positions of the target and the anchor. The coordinates of the contours are quite coarse, and generally only accurate to within a couple of pixels. A corner refinement technique is used which involves iteratively solving a least-squares system based on the pixel values in the region of the corner. It converges nicely to a sub-pixel accurate estimate of the corner position. In practice, this has proved one of the hardest things to get right.

It is also critical for the accuracy of the application that the image coordinates are undistorted prior to computing the homography. The undistortion may perturb the corner image coordinates by several pixels, so it cannot be ignored.

All image contours are examined exhaustively until all targets in the image are found. A list is returned of the targets found, their IDs, and, if the video imaging source calibration parameters are available, their positions and orientations.

Having provided a general overview, the present invention will now be described more specifically with respect to the mathematical calculations unique to the present invention and system.

The pose of the target is computed using planar pose estimation. To perform planar pose estimation for a single video imaging source, the following is needed:
1) The calibration matrix K of the video imaging source;
2) the image coordinates of the planar object (the target) whose pose is being computed; and
3) the real-world dimensions of the planar object.

First the 2d planar homography H between the ideal target coordinates and the measured image coordinates are computed. The standard SVD-based (SVD: Singular Value Decomposition) least squares approach is used, for efficiency, which yields sufficient accuracies (See “Multiple View Geometry”, 2^{nd} ed., Hartley and Zisserman for details on homography estimation). The calibration library supports a non-linear refinement step (using the Levenberg-Marquardt algorithm) if the extra accuracy is deemed worth the extra computational expense, but that hasn't appeared necessary so far.

Then the fact that H=K[R′|t] up to a homogeneous scale factor, where R′ is the first two columns of the camera rotation matrix, and t=−RC, where C is the camera center is used. R and C are the objective—the pose of the video imaging source with respect to the target, which is inverted to get the pose of the target with respect to the video imaging source. In brief:

[R′|t]=K⁻¹H

The final column of the rotation matrix is computed by finding the cross product of the columns of R′, and normalize the columns. Noise and error will cause R to depart slightly from a true rotation, and to correct this, an SVD of R=UWV^{t} and take R=UV^{t}, which yields a true rotation matrix is used.

Things get a bit more complicated when multiple video imaging sources are involved. At the end of the calibration procedure, there are estimates of the poses of all video imaging sources in a global video imaging source coordinate system. Each video imaging source which can identify a target will generate its estimate for the pose of the target with respect to itself. The task then is to estimate the pose of the target with respect to the global coordinate system. A non-linear refinement step is used for this purpose (in this case, the quasi-Newton method, which proved to have better convergence characteristics than the usual stand-by, Levenberg-Marquardt). The aim in this step is to find the target pose which minimizes the reprojection error in all video imaging sources.

This last step may not be necessary in many deployment scenarios, and is only required if all pose estimates are needed in a single global coordinate system.

### Calibration

Planar pose estimation requires a calibrated video imaging source. The system calibrates each individual video imaging source's so-called intrinsic parameters (x and y focal lengths, principal point and 4 to 6 distortion parameters), and, in the case of a multi-video imaging source setup, the system also calibrates the video imaging sources to each other.

The distortion parameters are based on a polynomial model of radial and tangential distortion. The distortion parameters are k₁, k₂, p₁, p₂, and (x_{c}, y_{c}). In the distortion model, an ideally projected point (x, y) is mapped to (x′, y′) as follows:

x′=x+x(k₁r²+k₂r⁴)+2p₁xy+p₂(r²+2x²)

y′=y+y(k₁r²+k₂r⁴)+2p₁xy+p₂(r²+2y²)

where r²=(x−x_{c})²+(y−y_{c})² and (x_{c}, y_{c}) is the center of distortion. In practice, the points extracted from the image are the (x′, y′) points, and the inverse relation is required. Unfortunately, it is not analytically invertible, so x and y are retrieved numerically through a simple fixed point method. It converges very quickly—five iterations suffice.

The distortion parameters are either discovered in the calibration process during homography estimation—in particular, during the non-linear refinement step, where they are simply added to the list of parameters being sought to refine—or in a separate image-based distortion estimation step, where a cost function is minimized based on the straightness of projected lines. The latter approach appears to give marginally better results, but requires a separate calibration step for the distortion parameters alone, and so the complete calibration takes a bit longer. In practice, the former approach has been used with very good results.

To calibrate a video imaging source, the system takes several images of a plate with a special calibration pattern on it. This requires holding the plate in a variety of orientations in front of the video imaging source while it acquires images of the pattern. The system calibrates the video imaging source's focal length, principle point, and its distortion parameters. The distortion parameters consist of the center of distortion and 4 polynomial coefficients. Roughly 10 images suffice for the video imaging source calibration. The computation takes a few seconds (generally less than five) per video imaging source.

The system can group multiple video imaging sources into shared coordinate systems. To do this, the system has to establish where the video imaging sources are in relation to each other. For this the system takes images of the calibration pattern so that at least part of the pattern is visible to more than one video imaging source at a time (there must be at least some pair-wise intersection in the viewing frustums of the video imaging sources).

The system uses graph theoretic methods to analyze a series of calibration images acquired from all video imaging sources in order to determine 1) if the system has enough information to calibrate the video imaging sources to each other; 2) to combine that information in a way that yields an optimal estimate for the global calibration; and 3) to estimate the quality of that calibration. The optimal estimate is computed through a non-linear optimization step (quasi-Newton method).

To find the coordinate system groupings, a graph is constructed whose vertices consist of video imaging sources, and whose edges consist of the shared calibration target information. The graph is partitioned into its connected components using a depth-first-search approach. Then the calibration information stored in the edges is used to compute a shared coordinate system for all the video imaging sources in the connected component. If there is only one connected component in the graph, the result is a single, unified coordinate system for all video imaging sources.

Proof of concept during product development was established using firewire video imaging sources, which comes with a simple, software development kit (SDK). The present invention has been designed to avoid dependance on any single vendor's SDK or video imaging source, and to use Windows standard image acquisition APIs (like DirectShow, for instance).

The present invention works well using targets printed with an ordinary laser printer and using only ambient light, but for really robust operation, it has been demonstrated that optimal results are achieved with targets printed in matte black vinyl on white retro-reflective material and infrared ring lights 40 incorporated on the video imaging source and infrared filters on the lenses 42 as shown on FIG. 3. The combination of ring lights on the video imaging source and retro-reflective material yields excellent stability and very high contrast, and the infrared filters cut out ambient light to a very high degree.

The present invention operates in an autonomous computer or dedicated embedded system which may be part of the video source. Best results have been obtained with communication of the tracking results to other applications via XML packets sent over TCP. Other data formatting or compression techniques and communication methods can be used to propagate the data.

The present invention acquires images on all video imaging sources, and combines the results in the case of a multi-video imaging source calibration. The information on all targets found in the video imaging source images is compiled into a packet like the following example:

```
<Tool TrackerInspection time=“15:08:24:87” date=“2005-10-05”
tracker_id=“WEP_TT_04”>
  <Targets>
    <Target target_id=“531159” x=“1.24” y=“24.5” z=“−9.44”
q1=“.0111” q2=“−0.7174” q3=“−0.4484” q4=“.0654” >
      <OffsetPosition x=“2.432” y=“4.333” z=“−7.64 6” />
    </Target>
  <Target target_id=“2509” x=“4.24” y=“29.5” z=“−19.74”
q1=“.0111” q2=“−0.7174” q3=“− 0.4484” q4=“.0654” />
  </Targets>
</Tool TrackerInspection>
```

The following is a description of the above example of XML packet:: The root element “ToolTrackerInspection” defines the date and time of the packet, and identifies the tracker that is the source of the packet. What follows is a list of targets found in the images acquired by the video imaging sources. It will be noted that the first Target element (with id=531159) has a sub element called OffsetPosition. This is because this target has an end-of-device offset associated with it. This offset has to be set up beforehand in the tracker. This packet is received by an interested application which performs the actual work-validation logic, or other application logic. The XML packet above has returned values based upon a Quaternion transformation. It should be noted that Euler notations can also be obtained from the invention.

The foregoing description of the invention has been presented for the purposes of illustration and description. It is not intended to be exhaustive or to limit the invention to the precise form disclosed. Many modifications and variations are possible in light of the above teaching.

As used herein, the terms “comprises” and “comprising” are to construed as being inclusive and opened rather than exclusive. Specifically, when used in this specification including the claims, the terms “comprises” and “comprising” and variations thereof mean that the specified features, steps or components are included. The terms are not to be interpreted to exclude the presence of other features, steps or components.

What is claimed as the invention is:

1. A tracking system for tracking the use of an object with six degrees of freedom on a work piece or within a predetermined work space comprising:
at least one target attached to the object at a calibrated location, each target having a predetermined address space and a predetermined anchor;
at least one video imaging source arranged such that the work piece is within the field of view, each video imaging source adapted to record images within its field of view; and
a computer for receiving the images from each video imaging source and comparing the images with the predetermined anchor and the predetermined address, calculating the location of the target and the object attached thereto in the work space relative to the work piece.

2. A tracking system as claimed in claim 1 wherein the target is generally planar.

3. A tracking system as claimed in claim 2 wherein at least one video imaging source includes a plurality of video imaging sources.

4. A tracking system as claimed in claim 3 wherein each video imaging source further includes an infrared ring light.

5. A tracking system as claimed in claim 4 wherein each video imaging source further includes an infrared filter.

6. A tracking system as claimed in claim 2 wherein the target is a uniquely identified target.

7. A tracking system as claimed in claim 6 wherein the uniquely identified target is a two dimensional datamatrix.

8. A tracking system as claimed in claim 7 wherein the target is a matte black vinyl on white retro-reflective material.

9. A tracking system as claimed in claim 2 wherein the target has a plurality of planar faces.

10. A tracking system as claimed in claim 2 wherein the target has a bit coded address space.

11. A tracking system as claimed in claim 2 further including a plurality of targets.

12. A tracking system as claimed in claim 1 wherein the object is adapted to be moveable.

13. A tracking system as claimed in claim 1 whereby the object tracking point is calculated by means of calculating the offset to the target

14. A tracking system as claimed in claim 1 wherein the object is a first object and further including a plurality of objects each object having at least one unique target attached thereto.

15. A tracking system as claimed in claim 1 wherein the means for recording is a video imaging source having a pivot point, the target has a pose with respect to the video imaging source and the object has an end-of-object offset in a target coordinate system and wherein the means for calculating the position of the object is determined using a formula given by
p=P_{CD}v
wherein p is the position of the pivot point in the video imaging source coordinate system, P_{CD} is the pose of the target with respect to the video imaging source, and v is the end-of-object offset in the target coordinate system.

16. A tracking system as claimed in claim 15 wherein the means for calculating the position of the object is further determined using a formula given by:
P=Rv+t
wherein R is a rotation of the target with respect to the video imaging source and t is the translation of the target with respect to the video imaging source.

17. A tracking system as claimed in claim 16 wherein the pose of the target is computed using a planar pose estimation.

18. A tracking system for tracking a moveable object for use on a work piece within a predetermined work space comprising;
a target adapted to be attached to an object;
a means for recording the location of the object within the workspace; and
a means for calculating the position of the object relative to the work piece from the recorded location.

19. A tracking system as claimed in claim 18 wherein the means for recording is a video imaging source having a pivot point, the target has a pose with respect to the video imaging source and the object has an end-of-object offset in a target coordinate system and wherein the means for calculating the position of the object is determined using a formula given by
p=P_{CD}v
wherein p is the position of the pivot point in the video imaging source coordinate system, P_{CD} is the pose of the target with respect to the video imaging source, and v is the end-of-object offset in the target coordinate system.

20. A tracking system as claimed in claim 19 wherein the means for calculating the position of the object is further determined using a formula given by:
P=Rv+t
wherein R is a rotation of the target with respect to the video imaging source and t is the translation of the target with respect to the video imaging source.

21. A tracking system as claimed in claim 20 wherein the pose of the target is computed using a planar pose estimation.
